(19) United States
(12) Patent Application Publication
(10) Pub. No.: US 2022/0366225 A1
(43) Pub. Date: Nov. 17, 2022

(54) SYSTEMS AND METHODS FOR REDUCING POWER CONSUMPTION IN COMPUTE CIRCUITS

(71) Applicant: Maxim Integrated Products, Inc., San Jose, CA (US)

(72) Inventors: Mark Alan LOVELL, Lucas, TX (US); Robert Michael MUCHSEL, Addison, TX (US)

(73) Assignee: Maxim Integrated Products, Inc., San Jose, CA (US)

(21) Appl. No.: 17/320,453

(22) Filed: May 14, 2021

(51) Int. Cl. G06N 3/063; G06N 3/04

(52) U.S. Cl. CPC G06N 3/063; G06N 3/04

(57) ABSTRACT

Systems and methods allow existing hardware, such as commonly available hardware accelerators to process fully connected network (FCN) layers in an energy-efficient manner and without having to implement additional expensive hardware. Various embodiments, accomplish this by using a “flattening” method that converts a channel associated with a number of pixels into a number of channels that equals the number pixels.

### BACKGROUND

### A. Technical Field

The present disclosure relates generally to data processing in machine-learning applications. More particularly, the present disclosure relates to systems and methods for efficiently performing arithmetic operations in fully connected network (FCN) layers using compute circuits.

### B. Background

Machine learning is a subfield of artificial intelligence that enables computers to learn by example without being explicitly programmed in a conventional sense. Numerous machine learning applications utilize a Convolutional Neural Network (CNN), i.e., a supervised network that is capable of solving complex classification or regression problems, for example, for image or video processing applications. A CNN uses as input large amounts of multi-dimensional training data, such as image or sensor data to learn prominent features therein. A trained network can be fine-tuned to learn additional features. In an inference phase, i.e., once training or learning is completed, the CNN uses unsupervised operations to detect or interpolate previously unseen features or events in new input data to classify objects, or to compute an output such as a regression. For example, a CNN model may be used to automatically determine whether an image can be categorized as comprising a person or an animal. The CNN applies a number of hierarchical network layers and sub-layers to the input image when making its determination or prediction. A network layer is defined, among other parameters, by kernel size. A convolutional layer may use several kernels that apply a set of weights to the pixels of a convolution window of an image. For example, a two-dimensional convolution operation involves the generation of output feature maps for a layer by using data in a two-dimensional window from a previous layer.

One particularly useful operation is the fully connected (FC) operation, also known as linear layer or Multi-Layer Perceptron (MLP). Although CNNs primarily make use of CNN operations, an FC layer is often used as the last layer, where it may be called the “classification” layer. A common technique for increasing the utilization of both computation time and storage space for weights in many network layers is made possible by the fact that all nodes for a filter can share the same set of weights. This technique involves weight-sharing, i.e., reusing the same weights for each combination of input and output frames. However, such techniques are not applicable to complex FCN layers in which one weight for each combination of input and output pixel is required. Accordingly, the computational complexity of FCN layers and excessive power consumption associated therewith makes hardware acceleration and power-saving systems and methods particularly desirable.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 is a general illustration of a conventional embedded machine learning accelerator system.

FIG. 2A & FIG. 2B illustrate a process for flattening data according to various embodiments of the present disclosure.

FIG. 3 illustrates an exemplary block diagram of a low-power system for emulating an MLP according to various embodiments of the present disclosure.

FIG. 4 is a flowchart of an illustrative process for flattening data according to various embodiments of the present disclosure.

FIG. 5 is a flowchart of an illustrative process for reducing in power consumption in a compute system such as that shown in FIG. 3.

FIG. 6 depicts a simplified block diagram of a computing device/information handling system, in accordance with embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Each reference mentioned in this patent document is incorporate by reference herein in its entirety.

It shall be noted that embodiments described herein are given in the context of embedded machine learning accelerators, but one skilled in the art shall recognize that the teachings of the present disclosure are not so limited and may equally reduce power consumption in related or other devices.

In this document the terms “memory,” “memory device,” and “register” are used interchangeably. Similarly, the terms kernel, weight, parameter, and weight parameter are used interchangeably. “Neural network” includes any neural network known in the art. The term “hardware accelerator” refers to any type of electrical or optical circuit that may be used to perform mathematical operations and related functions, such as auxiliary control functions.

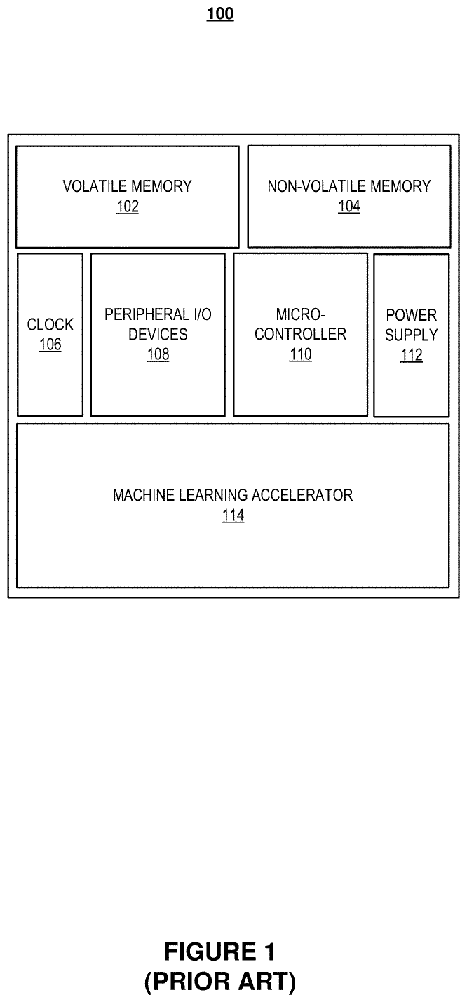

FIG. 1 illustrates a conventional embedded machine learning accelerator system that processes data in multiple stages. System 100 contains volatile memory 102, non-volatile memory 104, clock 106, clock I/O peripherals, microcontroller 110, power supply 112, and machine learning accelerator 114. Microcontroller 110 can be a traditional DSP or general-purpose computing device, machine learning accelerator 114 can be implemented as a CNN accelerator that comprises hundreds of registers (not shown). As depicted in FIG. 1, machine learning accelerator 114 interfaces with other parts of embedded machine learning accelerator system 100.

In operation, microcontroller 110 performs arithmetic operations for convolutions in software. Machine learning accelerator 114 typically uses weight data to perform matrix-multiplications and related convolution computations on input data using weight data. The weight data may be unloaded from accelerator 114, for example, to load new or different weight data prior to accelerator 114 performing a new set of operations using the new set weight data. More commonly, the weight data remains unchanged, and for each new computation, new input data is loaded into accelerator 114 to perform the computations. Machine learning accelerator 114 lacks hardware acceleration for at least some of a number of possible neural network computations. These missing operators are typically emulated in software by using software functions embedded in microcontroller 110. However, such approaches are very costly in terms of both power and time; and for many computationally intensive applications (e.g., real-time applications) general purpose computing hardware is unable to perform the necessary operations in a timely manner as the rate of calculations is limited by the computational resources and capabilities of existing hardware designs.

Further, using arithmetic functions of microcontroller 110 to generate intermediate results comes at the expense of computing time due to the added steps of transmitting data, allocating storage, and retrieving intermediate results from memory locations to complete an operation. For example, many conventional multipliers are scalar machines that use CPUs or GPUs as their computation unit and that use registers and a cache to process data stored in non-volatile memory relying on a series of software and hardware matrix manipulation steps, such as address generation, transpositions, bit-by-bit addition and shifting, converting multiplications into additions and outputting the result into some internal register. In practice, these repeated read/write operations performed on, for example, a significant amount of weight parameters and input data with large dimensions and/or large channel count, result in undesirable data movements in the data path and, thus, increase power consumption. There exist no mechanisms that efficiently select and use data, while avoiding generating redundant data and avoiding accessing data in a redundant fashion. Software must access the same locations of a standard memory and read, re-fetch, and write the same data over and over again even when performing simple arithmetic operations, which is computationally very burdensome and creates a bottleneck that curbs the boon for machine learning applications.

As the amount of data subject to convolution operations increases and the complexity of operations continues to grow, the added steps of storing and retrieving intermediate results from memory to complete an arithmetic operation present only some of the shortcoming of existing designs. In short, conventional hardware and methods are not well-suited for accelerating computationally intensive FC layers or performing a myriad of other complex processing steps that involve efficiently processing large amounts of data.

Accordingly, what is needed are systems and methods that allow existing hardware, such as conventional two-dimensional hardware accelerators, to perform arithmetic operations on FCNs and other network layers in an energy-efficient manner and without increasing hardware cost.

An FCN operates on one weight per input pixel since each pixel (and channel) on the input has its own weight when being connected to each pixel (and channel) on the output. For similar reasons, FCNs are also relatively harder to train that typical network layers in a CNN, especially, on deep neural networks (DNNs) used in modern image processing. In comparison, a typical CNN layer operates on one set of weights per input channel, thus, rendering conventional hardware accelerators unsuitable for FCN operations.

Therefore, various embodiments presented herein enable the desired one-weight-per-pixel relationship on conventional hardware accelerators architectures to associate each channel with one pixel, such that applying one weight per pixel is equivalent to applying one weight per channel that conventional hardware accelerators are capable of handling. Certain embodiments accomplish this by using a “flattening” method that involves converting a number of channels that each is associated with a number of pixels into a number of channels that equals the number of pixels.

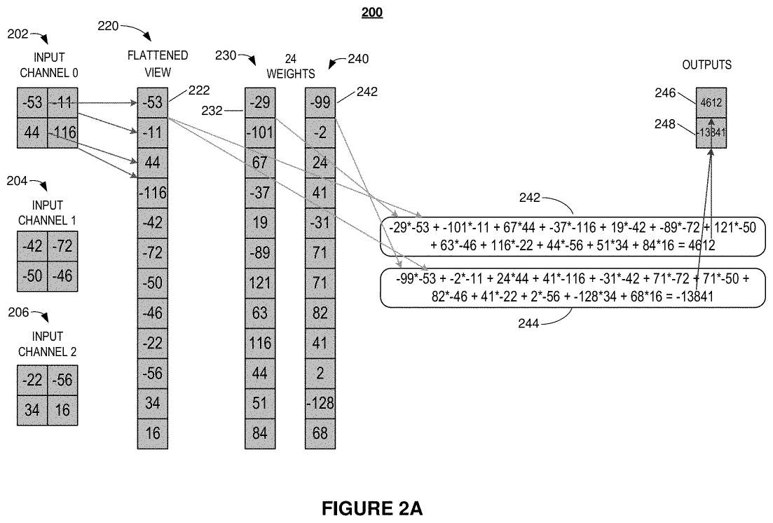

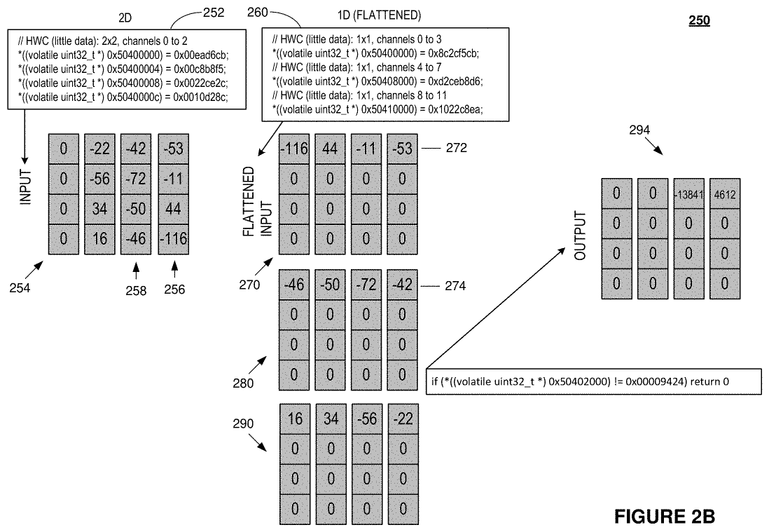

FIG. 2A and FIG. 2B illustrate a process for flattening data for emulating an FCN according to various embodiments of the present disclosure. FIG. 2A depicts three 2×2 input channels 202-204, a flattened view 220 of input channels 202-204 as twelve input channels to which two sets of weights, 230 and 240 respectively, are applied to obtain two output pixels or channels 246, 248.

As depicted in FIG. 2A, each byte of input data represents one channel 202-204, denoted as input channel 0 through input channel 2. It is understood that input data may comprise source data, such as image or audio data that may be read from memory, or output data obtained from a neural network layer that may precede an FCN layer and represents, for example, a (partial) input map or input matrix.

In embodiments, a number of input channels 202-204 that each is associated with, e.g., four input pixels may be flattened into an array of twelve channels 220 that each is associated with one pixel. In in this manner, flattening the input data of three different input channels 202-204 results in a one-pixel-per-channel flattened view 220. Stated differently, input channels 202-204 may be converted to input channel sizes that each corresponds to one pixel. As a result, one weight (e.g., 232) in the set of twelve weights 230 may be used per input channel or pixel (e.g., 222) per output channel or pixel (e.g., 246). As illustrated in FIG. 2A, a second set of twelve weights 240 may be used to obtain a second output pixel such that, for example, weight 242, here −99, when applied to pixel 222, here −53, delivers the value −13841 for the second output pixel 248.

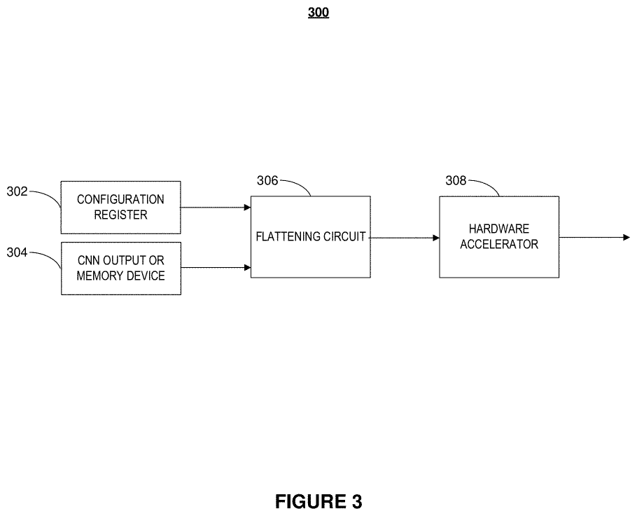

Flattened input data 220 in FIG. 2A represents twelve input neurons that may have been generated by a flattening circuit discussed in greater detail with reference to FIG. 3. And weights 230, 240 represent two sets of twelve weights that may have been determined and stored, e.g., in a training phase of a machine learning model. Output data 246, 248 represents two output neurons, one for each of the subset of weights 230 and 240, respectively.

In embodiments, once input data is flattened in this manner, a conventional two-dimensional convolutional accelerator (not shown in FIG. 2A) may be employed to perform operations associated with an MLP, advantageously, without incurring any additional hardware cost. In embodiments, the one-dimensional output of the flattening circuit is provided the input to a two-dimensional convolution hardware that computes a result in the same manner as if calculating an FCN, for example, to perform object detection in an image. In embodiments, the convolutional accelerator may apply the sets of weights 230, 240 to flattened input data 220 and accumulate the result, as shown, to obtain a convolution output 246, 248, e.g., by configuring one weight (e.g., 232) for each of the data inputs (e.g., 203) and performing integer or fixed-point multiply-and-accumulate operations (e.g., 242), in line with an FCN that convolves weights 230, 240 over the entirety of the input data 202-204, e.g., to obtain output pixel values 246, 248 for an image. Typical multiply-and-accumulate operations in a convolution involve scalar (dot product) operations, i.e., the summation of multiplication results that represent partial dot products that are obtained by element-wise multiplications of input data and weight data.

In embodiments, flattened data 220 may be used, for example, by a two-dimensional convolutional accelerator that reads the first data point associated with input channel 202; reads the first data point 232 associated with a first set of weight data; and then multiplies the two data points to obtain a first partial result. The accelerator also uses the first data point associated with input channel 202 and multiplies it with a first data point 242 associated with a second set of weight data to obtain a second partial result, and so on. As a person of skill in the art will appreciate, the convolutional accelerator may further perform different or additional operations such as, e.g., two-dimensional matrix multiplications that enable three-dimensional convolution operations.

It is noted that although two sets of weights 230, 240 are shown to generate two output pixels 246, 248, this is not intended as a limitation on the scope of the present disclosure. As a person of skill in the art will appreciate, any number of sets of weights may be applied to any number of input channels to obtain output channels or pixels. For example, instead of using input channels having a 2×2 format or size any other dimension may be processed.

FIG. 2B depicts a representation of input channel data 202-204 in FIG. 2A. Input representation 254 may be a hardware representation of input channel data 202-204, e.g., as stored in a memory device. Text boxes 252 and 260 in FIG. 2B comprise examples of partial programs that illustrate how programming may be used to specify how to load and flatten channel data 202-204.

In embodiments, input representation 254 replicates the input channel data in FIG. 2A across different columns of a two-dimensional matrix. While such a two-dimensional matrix format is commonly used for a convolution operation performed on a two-dimensional hardware accelerator, in embodiments, in order to facilitate one or more linear operations that allow processing of an FCN, input representation 254 is mapped to a number of pixels in input channels represented by the contents of two-dimensional matrix 254, i.e., the number of pixels of the input channels 202-204 depicted in FIG. 2A. In embodiments, this mapping corresponds to a dimension conversion from a two-dimensional matrix format into a 1×1 height and width format, where each matrix element is associated with one pixel.

In detail, in embodiments, input data 254 that has a size or shape HWC, where C represents the number of channels, each having a height coordinate H and a width coordinate W, is interpreted as a number of H×W×C channels, each channel having a height of 1 and a width of 1. In embodiments, doing so increases the number of input channels and allows input data 202-206 to be flattened into a string or concatenated data array of flattened data 220.

To accomplish this, in embodiments, the last column 256 of input matrix 254 in FIG. 2B, which represents channel 0, may be treated as the first row 272 in a first stack or input matrix 270; the second to last column 258, which represents channel 1, may be treated as the first row 274 in a second stack 280, and so on. In short, input matrix 254 in FIG. 2B may be treated as being converted or rewritten in a way such that each input channel (e.g., 256) becomes a first row in a two-dimensional matrix (e.g., 272) and is associated with that input channel (e.g., channel 0). As a result, channel 0 in stack 270 comprises a single value, −53, that is associated with one pixel; channel 1 comprises a single value, −11, associated with one pixel; etc. In other words, each channel is associated with one value, e.g., a pixel value.

In embodiments, the second through fourth rows in matrices 270, 280, and 290 may be filled with zeroes or interpreted as if filled with zeroes to maintain the two-dimensional matrix format such that each column in the flattened input view comprises one pixel to accommodate the one-weight-per-channel format required by conventional hardware accelerators. One result of treating input matrix 254 as expanded into three two-dimensional matrices 270, 280, and 290 is that data in input matrix 254 may be treated as having been rearranged into a format that is compatible with an input-output combination suitable for an existing two-dimensional hardware accelerator circuit that may, advantageously, be repurposed to process a FCN without having to implement into a system an additional, and likely underutilized, special hardware block that is customized to process FCNs. Finally, to emulate a linear FCN operation, the flattened input may be used, e.g., according to the calculations shown in FIG. 2A, to generate output 294.

In embodiments, treating input channels as each comprising a single pixel, which changes how an existing hardware accelerator retrieves and/or reads input data, may be implemented by a flattening circuit, as will be discussed next. It is noted that, in embodiments, various different or additional implementation-specific steps may be used. Exemplary additional steps may include scaling operations, such as the scaling of output values by a predetermined factor in order to account for not having to store denominator values, which may be treated as implicit in a series of calculations.

FIG. 3 illustrates an exemplary block diagram of a low-power system for emulating an MLP according to various embodiments of the present disclosure. System 300 comprises configuration register 302, CNN output or memory device 304, flattening circuit 306, and hardware accelerator 308. In embodiments, configuration register 302 may be implemented as an on-board processor storage or a type of circuit, e.g., a dedicated physical register that may be dynamically allocated. Configuration register 302 may further be used to store instructions that identify operands having various bits and/or other data. Flattening circuit 306 may flatten the data as discussed above with reference to FIG. 2A and FIG. 2B.

In embodiments, flattening circuit 306 may comprise a combination of multipliers, adders, multiplexers, delay elements such as input latches, control logic such as a state machine, and other components or sub-circuits. Hardware accelerator 308 may comprise any existing computation engine known in the art, such as a conventional two-dimensional CNN accelerator, that in embodiments may comprise memory that has a two-dimensional data structure.

In operation, flattening circuit 306 may receive, fetch, load otherwise obtain input data from memory device 304 or data that has been output by a convolutional layer in a neural network. In embodiments, the input data may comprise, e.g., audio data, image data, or any data derived therefrom. It is understood that, in embodiments, input data may be streamed directly into flattening circuit 306 instead of being retrieved from memory device 304.

Input data may comprise input size information, such as height and width information, which may be obtained from configuration register 302, e.g., along with image data. In embodiments, flattening circuit 306 may use the information to flatten the data. In embodiments, the format of the input may be altered, e.g., by changing register values in hardware that configures the size of the input data such as to ascertain from where to retrieve each next bit or pixel and use it when flattening is activated or enabled.

In embodiments, flattening circuit 306 may be enabled, e.g., by setting a configuration bit, such that fattening may be performed virtually, i.e., without having to physically move around data, e.g., without copying the data into a string and then moving the data. As a person of skill in the art will appreciate, in embodiments, virtualization may be accomplished by using proper allocation of target addresses, e.g., such that several pieces of data may be loaded and subsequently used without having to explicitly reconfigure target addresses, pointers, and the like. Unlike address or data mechanisms used in conventional software implementations, which invariably move data in and out of memory devices and intermediate data storage, various embodiments herein, advantageously, aid in significantly reducing data movement and power consumption.

In embodiments, the output of flattening circuit 306 may be provided to hardware accelerator 308 that may process the output of flattening circuit 306, e.g., using an FC operation to obtain an inference result. It is understood that components in FIG. 3 or auxiliary components (not shown) may perform additional steps, such as pre-processing data, e.g., to modify the input of flattening circuit 306 or hardware accelerator 308, e.g., to perform useful data transformation and other data manipulating steps. It is further understood that some or all portions of system 300 may be used to perform any number of machine learning steps and calculations during inference (prediction) and/or training (learning).

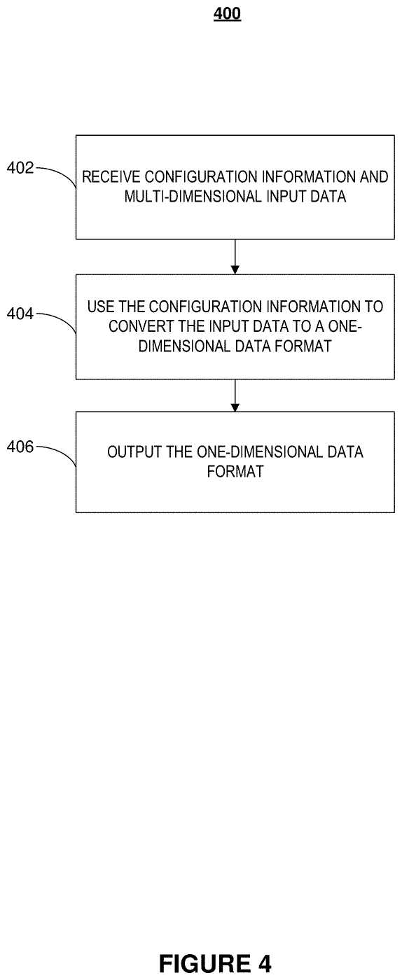

FIG. 4 is a flowchart of an illustrative process for flattening data according to various embodiments of the present disclosure. In embodiments, process 400 may begin, at step 402, when an input of a flattening circuit receives configuration information, e.g., from a configuration register. The same or a differently input may further receive multi-dimensional input data, for example, from a memory or from the output of a neural network layer. Exemplary configuration information may comprise parameters that determine which operation are to be performed in which order. In embodiments, the configuration information may comprise height and width data that is associated with a network layer or with the input data itself.

At step 404, the flattening circuit may, based on the received configuration information to convert the input data into a one-dimensional data format, e.g., as illustrated in FIG. 2A and FIG. 2B. In embodiments, the input data may comprise one or more two-dimensional data matrices.

At step 406, the flattening circuit may output the converted data comprising a one-dimensional data format to be further processed, e.g., by one or more layers of a neural network. In embodiments, such further processing may be performed by the flattening circuit itself, e.g., by using a sub-circuit the flattening circuit. Alternatively, a different circuit, e.g., a separate hardware accelerator may be used, such as the hardware accelerator depicted in FIG. 3 that may be configured to process two-dimensional convolutional operations.

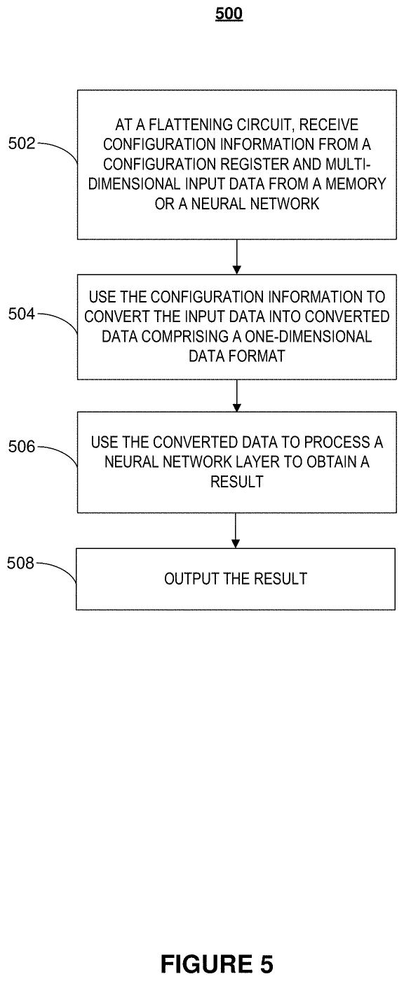

FIG. 5 is a flowchart of an illustrative process for reducing in power consumption in a compute system such as that shown in FIG. 3. In embodiments, process 500 may begin when, at step 502, a flattening circuit receives configuration information, e.g., from a configuration register, and further receives multi-dimensional input data, e.g., from a memory or from the output of a neural network layer, such as a CNN layer.

At step 504, the flattening circuit may use the received configuration information to convert the input data into a one-dimensional data format, as illustrated in FIG. 2.

At step 506, the converted data may be used to process at least one fully connected network layer to obtain a result, e.g., the result of an inference or related operation.

Finally, at step 508, the result may be output.

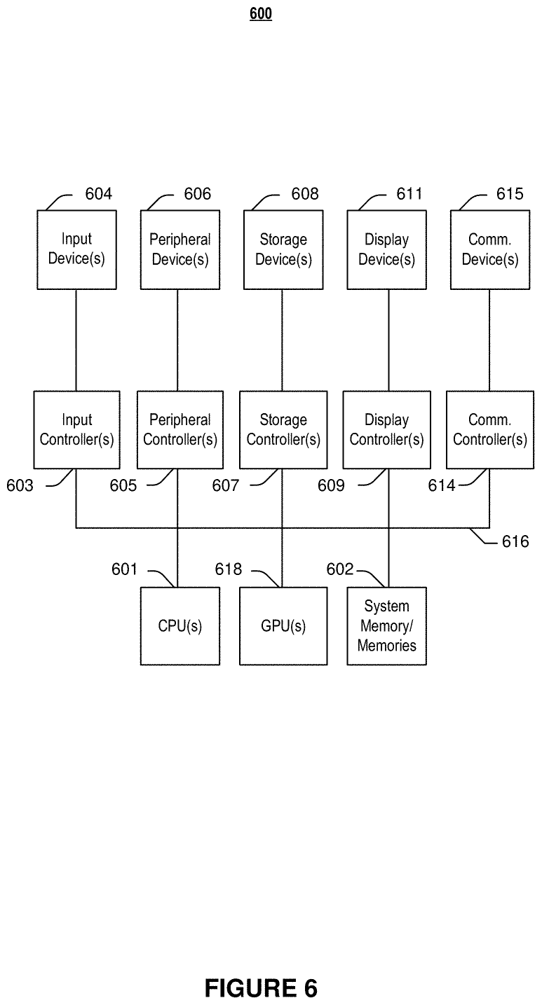

FIG. 6 depicts a simplified block diagram of an information handling system (or computing system) according to embodiments of the present disclosure. It will be understood that the functionalities shown for system 600 may operate to support various embodiments of a computing system—although it shall be understood that a computing system may be differently configured and include different components, including having fewer or more components as depicted in FIG. 6.

As illustrated in FIG. 6, the computing system 600 includes one or more CPUs 601 that provides computing resources and controls the computer. CPU 601 may be implemented with a microprocessor or the like, and may also include one or more graphics processing units 619 and/or a floating-point coprocessor for mathematical computations. System 600 may also include a system memory 602, which may be in the form of random-access memory (RAM), read-only memory (ROM), or both.

A number of controllers and peripheral devices may also be provided, as shown in FIG. 6. An input controller 603 represents an interface to various input device(s) 604, such as a keyboard, mouse, touchscreen, and/or stylus. The computing system 600 may also include a storage controller 607 for interfacing with one or more storage devices 608 each of which includes a storage medium such as magnetic tape or disk, or an optical medium that might be used to record programs of instructions for operating systems, utilities, and applications, which may include embodiments of programs that implement various aspects of the present disclosure. Storage device(s) 606 may also be used to store processed data or data to be processed in accordance with the disclosure. The system 600 may also include a display controller 609 for providing an interface to a display device 611, which may be a cathode ray tube (CRT), a thin film transistor (TFT) display, organic light-emitting diode, electroluminescent panel, plasma panel, or other type of display. The computing system 600 may also include one or more peripheral controllers or interfaces 605 for one or more peripherals 606. Examples of peripherals may include one or more printers, scanners, input devices, output devices, sensors, and the like. A communications controller 614 may interface with one or more communication devices 615, which enables the system 600 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. Processed data and/or data to be processed in accordance with the disclosure may be communicated via the communications devices 615. For example, loader circuit 506 in FIG. 5 may receive configuration information from one or more communications devices 615 coupled to communications controller 614 via bus 616.

In the illustrated system, all major system components may connect to a bus 616, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as ASICs, programmable logic devices (PLDs), flash memory devices, and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as ASICs, PLDs, flash memory devices, and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for reducing computing power, the method comprising:
in response to receiving configuration information comprising height and width information and receiving input data comprising a multi-dimensional input format, using the configuration information to convert the input data to obtain converted data that comprises a one-dimensional data format;
using the converted data to process a neural network layer to obtain a result; and
outputting the result.

2. The method according to claim 1, wherein processing the neural network layer comprises using a fully connected operation.

3. The method according to claim 2, wherein the neural network layer is a multi-layer perceptron comprising nodes whose activation values deliver scores that indicate a likelihood that the input data is associated with an object.

4. The method according to claim 1, wherein the input data is received from at least one of a memory device or an output of a convolutional neural network layer.

5. The method according to claim 1, wherein the input data comprises a two-dimensional data matrix.

6. The method according to claim 1, wherein the converted data is processed by a convolutional neural network accelerator.

7. The method according to claim 6, wherein the convolutional neural network accelerator is configured to perform at least one of one-dimensional or two-dimensional convolutional operations.

8. The method according to claim 6, wherein the convolutional neural network accelerator comprises memory to store the converted data.

9. The method according to claim 8, wherein the memory comprises a two-dimensional data structure.

10. The method according to claim 1, wherein converting the input data comprises using the configuration information to control one or more addresses.

11. A flattening circuit comprising:
one or more inputs to receive configuration information comprising height and width data associated with a network layer, the one or more inputs further to receive input data comprising a multi-dimensional input format,
circuitry that uses the configuration information to convert the input data to obtain converted data that comprises a one-dimensional data format; and
an output that outputs the converted data.

12. The flattening circuit according to claim 11, wherein the converted data enables a hardware accelerator to output a result that emulates a fully connected operation.

13. The flattening circuit according to claim 12, wherein the hardware accelerator is a two-dimensional convolutional neural network accelerator configured to perform at least one of one-dimensional or two-dimensional convolutional operations.

14. The flattening circuit according to claim 11, wherein the multi-dimensional input format is associated with an input image having a height and a width.

15. The flattening circuit according to claim 11, wherein the configuration information comprises weight parameters.

16. A system for reducing computing power, the system comprising:
a configuration register to store configuration information that comprises height and width information associated with a network layer;
a flattening circuit to receive the configuration information and input data that comprises a multi-dimensional input format, the flattening circuit converts the input data to obtain converted data that comprises a one-dimensional data format; and
a hardware accelerator coupled to the flattening circuit, the hardware accelerator using the converted data to process a neural network layer and output a result.

17. The system according to claim 16, wherein the input data is received from an output of a convolutional neural network layer.

18. The system according to claim 16, wherein the multi-dimensional input format is associated with an input image having a height and a width.

19. The system according to claim 16, wherein the hardware accelerator is a convolutional neural network accelerator that comprises a two-dimensional data structure.

20. The system according to claim 16, wherein the result emulates a fully connected operation.
